(19) United States
(12) Patent Application Publication
(10) Pub. No.: US 2025/0279050 A1
(43) Pub. Date: Sep. 4, 2025

(54) DISPLAY DEVICE

(71) Applicant: SAMSUNG DISPLAY CO., LTD., YONGIN-SI (KR)

(72) Inventors: Jun Hyun PARK, YONGIN-SI (KR); Bon Yong KOO, YONGIN-SI (KR); Hyun Joon KIM, YONGIN-SI (KR); Young Wan SEO, YONGIN-SI (KR); Ji Hoon YANG, YONGIN-SI (KR); Min Jae JEONG, YONGIN-SI (KR)

(21) Appl. No.: 18/949,245

(22) Filed: Nov. 15, 2024

(30) Foreign Application Priority Data
Mar. 4, 2024 (KR) 10-2024-0030871

(51) Int. Cl. G09G 3/3233; G09G 3/32; G09G 3/3266; G09G 3/3275

(52) U.S. Cl. CPC G09G 3/3233; G09G 3/32; G09G 3/3266; G09G 3/3275; G09G 2300/0819; G09G 2300/0852; G09G 2300/0861; G09G 2310/08; G09G 2320/045; G09G 2330/021

(57) ABSTRACT

A display device includes a pixel unit including pixels. Each pixel includes a light emitting element, a driving transistor controlling an amount of current flowing from a first power source line to a second power source line via the light emitting element in response to a voltage of a node, a write transistor connected between a first electrode of the driving transistor and a data line and turned on or off in response to a write scan signal, and an initialization transistor connected between an anode electrode of the light emitting element and an initialization power source line and turned on or off in response to an initialization scan signal. A low voltage of the write scan signal is set to a first gate low voltage, and a low voltage of the initialization scan signal is set to a second gate low voltage different from the first gate low voltage.

### CROSS-REFERENCE TO RELATED APPLICATION

This application claims priority under 35 U.S.C. § 119 to Korean Patent Application No. 10-2024-0030871, filed on Mar. 4, 2024, the disclosure of which is incorporated by reference herein in its entirety.

### TECHNICAL FIELD

Embodiments of the present inventive concept relate to a display device.

### DISCUSSION OF RELATED ART

As advancements are made in information technology, the utilization of a display device, such as a liquid crystal display device and an organic light emitting display device, which provides a user with information, is increasing. Such display devices may be used in a variety of devices, including a portable device. When used in a portable device, a display device having reduced power consumption is desirable.

### SUMMARY

Embodiments of the present inventive concept provide a display device that can reduce power consumption by increasing a gate low voltage of a scan signal or reducing a gate high voltage of the scan signal.

A display device according to embodiments of the present inventive concept includes a pixel unit including a plurality of pixels. Each of the pixels includes a light emitting element, a driving transistor configured to control an amount of current flowing from a first power source line to a second power source line via the light emitting element in response to a voltage of a first node, a write transistor connected between a first electrode of the driving transistor and a data line and configured to be turned on or off in response to a write scan signal, and an initialization transistor connected between an anode electrode of the light emitting element and an initialization power source line and configured to be turned on or off in response to an initialization scan signal. A low voltage of the write scan signal is set to a first gate low voltage, and a low voltage of the initialization scan signal is set to a second gate low voltage that is different from the first gate low voltage.

According to an embodiment, the write transistor and the initialization transistor are P-type transistors.

According to an embodiment, a high voltage of the write scan signal and a high voltage of the initialization scan signal are set to a gate high voltage.

According to an embodiment, the first gate low voltage is a voltage higher than the second gate low voltage.

According to an embodiment, the display device further includes a data driver configured to supply a data signal to the data line, a first scan driver configured to supply the write scan signal to a write scan line, and a second scan driver configured to supply the initialization scan signal to an initialization scan line.

According to an embodiment, the first scan driver includes a plurality of stage circuits. Each of the stage circuits includes an output unit configured to generate the write scan signal using a gate high voltage and the first gate low voltage, and a control unit configured to control the output unit.

According to an embodiment, the first scan driver includes a plurality of stage circuits. Each of the stage circuits includes an output unit configured to generate the write scan signal using a gate high voltage and a clock signal, and a control unit configured to control the output unit.

According to an embodiment, a high voltage of the clock signal is set to the gate high voltage, and a low voltage of the clock signal is set to the first gate low voltage.

A display device according to embodiments of the present inventive concept includes a pixel unit including a plurality of pixels. Each of the pixels includes a light emitting element, a driving transistor configured to control an amount of current flowing from a first power source line to a second power source line via the light emitting element in response to a voltage of a first node, a write transistor connected between the first node and a data line and configured to be turned on or off in response to a write scan signal, and an initialization transistor connected between an anode electrode of the light emitting element and an initialization power source line and configured to be turned on or off in response to an initialization scan signal. A high voltage of the write scan signal is set to a first gate high voltage, and a high voltage of the initialization scan signal is set to a second gate high voltage.

According to an embodiment, the write transistor and the initialization transistor are N-type transistors.

According to an embodiment, a low voltage of the write scan signal and a low voltage of the initialization scan signal are set to a gate low voltage.

According to an embodiment, the first gate high voltage is a voltage higher than the second gate high voltage.

According to an embodiment, each of the pixels further includes a first emission transistor connected between a second electrode of the driving transistor and the anode electrode of the light emitting element and configured to be turned on or off by a first control scan signal, a second emission transistor connected between the first power source line and a first electrode of the driving transistor and configured to be turned on or off by an emission control signal, a control transistor connected between a reference power source line and the first node and configured to be turned on or off by a second control scan signal, a first capacitor connected between the first node and the second electrode of the driving transistor, and a second capacitor connected between the first power source line and the second electrode of the driving transistor. The first emission transistor, the second emission transistor, and the control transistor are N-type transistors.

According to an embodiment, a high voltage of each of the first control scan signal, the second control scan signal, and the emission control signal is set to the first gate high voltage, and a low voltage of each of the first control scan signal, the second control scan signal, and the emission control signal is set to a gate low voltage.

According to an embodiment, a high voltage of each of the first control scan signal and the emission control signal is set to the first gate high voltage, and a low voltage of each of the first control scan signal and the emission control signal is set to a gate low voltage. Further, a high voltage of the second control scan signal is set to the second gate high voltage, and a low voltage of the second control scan signal is set to the gate low voltage.

According to an embodiment, the display device further includes a data driver configured to supply a data signal to the data line, a first scan driver configured to supply the write scan signal to a write scan line, and a second scan driver configured to supply the initialization scan signal to an initialization scan line.

According to an embodiment, the second scan driver includes a plurality of stage circuits. Each of the stage circuits includes an output unit configured to generate the initialization scan signal using the second gate high voltage and a gate low voltage, and a control unit configured to control the output unit.

A display device according to embodiments of the present inventive concept includes a pixel unit including a plurality of pixels connected to a plurality of first scan lines, a plurality of second scan lines, and a plurality of data lines, a power source generator configured to generate a gate high voltage, a first gate low voltage, and a second gate low voltage using a first power source input from outside of the power source generator and a second power source having a voltage lower than the first power source, a scan driver configured to generate a first scan signal to be supplied to the first scan lines using the gate high voltage and the first gate low voltage, and configured to generate a second scan signal to be supplied to the second scan lines using the gate high voltage and the second gate low voltage, and a data driver configured to supply a data signal to the data lines.

### BRIEF DESCRIPTION OF THE DRAWINGS

The above and other features of the present inventive concept will become more apparent by describing in detail embodiments thereof with reference to the accompanying drawings.

FIG. 1 is a diagram illustrating a display device according to an embodiment of the present inventive concept.

FIG. 2 is a diagram illustrating a scan driver and an emission driver according to an embodiment of the present inventive concept.

FIG. 3 is a diagram illustrating a scan driver and an emission driver according to an embodiment of the present inventive concept.

FIG. 4 is a diagram illustrating a pixel according to an embodiment of the present inventive concept.

FIG. 5 is a waveform diagram illustrating an embodiment of a method of driving the pixel of FIG. 4 during a display scan period.

FIG. 6 is a waveform diagram illustrating an embodiment of a method of driving the pixel of FIG. 4 during a self-scan period.

FIGS. 7 and 8 are diagrams illustrating an embodiment of signals supplied during an active period and a blank period.

FIG. 9 is a diagram illustrating an embodiment of a stage circuit of a first scan driver.

FIG. 10 is a diagram illustrating an embodiment of a stage circuit of the first scan driver.

FIG. 11 is a diagram illustrating a scan driver and an emission driver according to an embodiment of the present inventive concept.

FIG. 12 is a diagram illustrating a pixel according to an embodiment of the present inventive concept.

FIG. 13 is a diagram illustrating an embodiment of a method of driving the pixel of FIG. 12 during a display scan period.

FIG. 14 is a diagram illustrating an embodiment of a method of driving the pixel of FIG. 12 during a self-scan period.

FIG. 15 is a diagram illustrating an embodiment of a stage circuit of a second scan driver shown in FIG. 11.

### DETAILED DESCRIPTION OF THE EMBODIMENTS

Embodiments of the present disclosure will be described more fully hereinafter with reference to the accompanying drawings. Like reference numerals may refer to like elements throughout the accompanying drawings.

Some embodiments are described with reference to the accompanying drawings in relation to a functional block, unit, and/or module. Those skilled in the art will understand that such a block, unit, and/or module may be physically implemented by, for example, a logic circuit, an individual component, a microprocessor, a hardwired circuit, a memory element, a line connection, and other electronic circuits, and may be formed using a semiconductor-based manufacturing technique or other manufacturing techniques. The block, unit, and/or module implemented by a microprocessor or other similar hardware may be programmed and controlled using software to perform various functions discussed herein, and may optionally be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more individual blocks, units, and/or modules without departing from the scope of the inventive concept. In addition, in some embodiments, the block, unit and/or module may be physically combined into more complex blocks, units, and/or modules without departing from the scope of the inventive concept.

The term “connection” between two components may mean that both of an electrical connection and a physical connection are used inclusively, but the present inventive concept is not limited thereto. For example, a “connection” with reference to a circuit diagram may mean an electrical connection, and a “connection” with reference to a cross-sectional view and a plan view may mean a physical connection.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

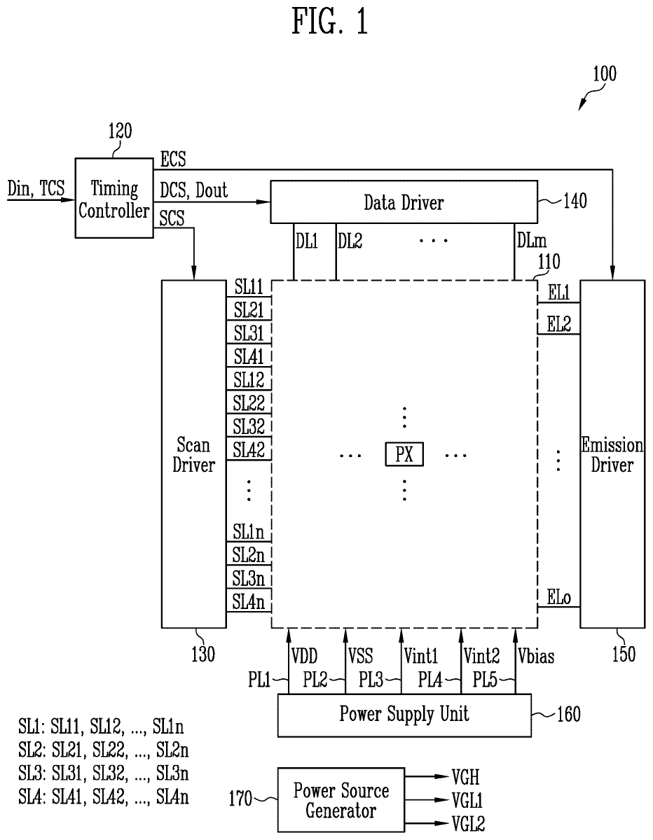

FIG. 1 is a diagram illustrating a display device according to an embodiment of the present inventive concept.

Referring to FIG. 1, a display device 100 according to an embodiment of the present inventive concept may include a pixel unit 110 (or display panel), a timing controller 120 (also referred to as a timing controller circuit), a scan driver 130 (also referred to as a scan driver circuit), a data driver 140 (also referred to as a data driver circuit), an emission driver 150 (also referred to as an emission driver circuit), a power supply unit 160 (also referred to as a power supply circuit), and a power source generator 170 (also referred to as a power source generator circuit).

The display device 100 may display images at various image refresh rates (driving frequencies or screen refresh rates) depending on driving conditions. The image refresh rate may refer to the frequency at which data signals are written to a driving transistor of a pixel PX. For example, the image refresh rate may be referred to as the screen refresh rate, and may indicate the frequency at which the display screen is refreshed for 1 second.

In an embodiment, in correspondence with the image refresh rate, an output frequency of the data driver 140 for one horizontal line (for example, pixels PX connected to the same scan line may be classified into one horizontal line (or pixel row)) and/or an output frequency of a first scan driver 132 outputting a first scan signal (or write scan signal) can be determined. For example, the image refresh rate for driving a moving image may be a frequency of about 60 Hz or higher (for example, about 120 Hz, about 240 Hz, etc.).

For example, the display device 100 may display images in response to various image refresh rates from about 1 Hz to about 240 Hz. However, this is only an example, and the display device 100 may display images at an image refresh rate of about 240 Hz or higher (for example, about 480 Hz) according to embodiments.

The pixel unit 110 may include pixels PX connected to first scan lines SL11, SL12, . . . , and SL1n, second scan lines SL21, SL22, . . . , and SL2n, third scan lines SL31, SL32, . . . , and SL3n, fourth scan lines SL41, SL42, . . . , and SL4n, data lines DL1, DL2, . . . , and DLm, emission control lines EL1, EL2, . . . , and ELo, and power source lines PL1, PL2, PL3, PL4, and PL5, where n, m, and o are positive integers greater than or equal to 2.

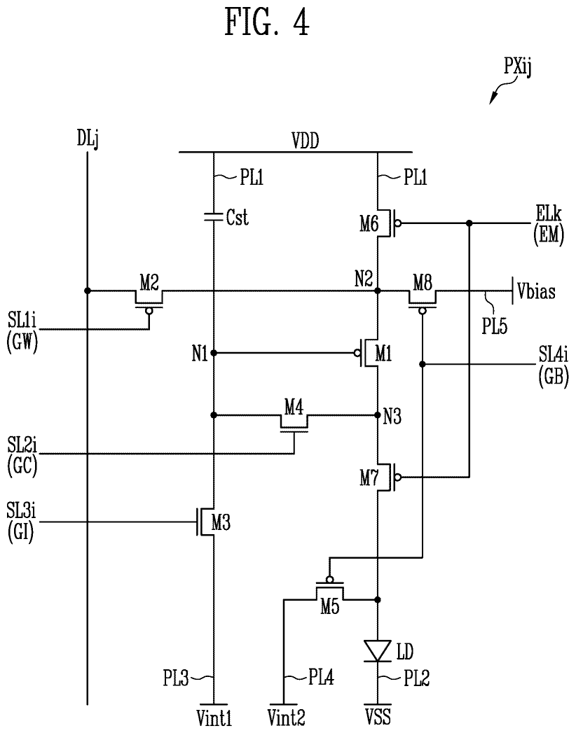

As an example, a pixel PXij (see FIG. 4) located on an i-th horizontal line (or pixel row) and a j-th vertical line (or pixel column) may be connected to an i-th first scan line SL1i, an i-th second scan line SL2i, an i-th third scan line SL3i, an i-th fourth scan line SL4i, a k-th emission control line ELk, and a j-th data line DLj, where i is a positive integer less than or equal to n, j is a positive integer less than or equal to m, and k is a positive integer less than or equal to o. Here, k is a number equal to or smaller than i. As an example, when each of the emission control lines EL1 to ELo is connected to pixels PX located on one horizontal line, k may be the same number as i. As an example, when each of the emission control lines EL1 to ELo is connected to pixels PX located on two or more horizontal lines, k may be a number smaller than i.

The pixels PX may be selected in units of horizontal lines when an enable first scan signal is supplied to the first scan lines SL11 to SL1n, and each of the pixels PX selected by the enable first scan signal may receive a data signal from a data line (any one of DL1 to DLm) connected thereto. The pixels PX that receive the data signal may generate light with a predetermined luminance in response to a voltage of the data signal.

The scan driver 130 may receive a scan driving signal SCS from the timing controller 120. The scan driving signal SCS may include at least one scan start signal and clock signals utilized to drive the scan driver 130. The scan driver 130 may generate an enable first scan signal, an enable second scan signal, an enable third scan signal, and an enable fourth scan signal while shifting the scan start signal in response to a clock signal.

The data driver 140 may receive output data Dout and a data driving signal DCS from the timing controller 120. The data driving signal DCS may include a sampling signal and/or timing signals utilized to drive the data driver 140. The data driver 140 may generate the data signal based on the data driving signal DCS and the output data Dout. As an example, the data driver 140 may generate an analog data signal based on a grayscale of the output data Dout. The data driver 140 may supply the data signal in units of one horizontal period.

The emission driver 150 may receive an emission driving signal ECS from the timing controller 120. The emission driving signal ECS may include an emission start signal and clock signals utilized to drive the emission driver 150. The emission driver 150 may generate a disable emission control signal EM while shifting the emission start signal in response to a clock signal.

The timing controller 120 may receive input data Din and a timing control signal TCS from a host system through an interface. As an example, the timing controller 120 may receive the input data Din and the timing control signal TCS from at least one of a graphics processing unit (GPU), a central processing unit (CPU), and an application processor (AP) included in the host system. The timing control signal TCS may include various signals including a clock signal.

The timing controller 120 may generate the scan driving signal SCS, the data driving signal DCS, and the emission driving signal ECS based on the timing control signal TCS. The scan driving signal SCS, the data driving signal DCS, and the emission driving signal ECS may be supplied to the scan driver 130, the data driver 140, and the emission driver 150, respectively.

The timing controller 120 may rearrange the input data Din to match the specifications of the display device 100. In addition, the timing controller 120 may correct the input data Din to generate the output data Dout and supply the output data Dout to the data driver 140. In an embodiment, the timing controller 120 may correct the input data Din in response to optical measurement results measured during a process.

The power supply unit 160 may generate various power sources utilized to drive the display device 100. As an example, the power supply unit 160 may generate a first driving power source VDD, a second driving power source VSS, a first initialization power source Vint1, a second initialization power source Vint2, and a bias power source Vbias.

The first driving power source VDD may be a power source that supplies driving current to the pixels PX. The second driving power source VSS may be a power source that receives driving current from the pixels PX. During a period in which the pixels PX are set to emit light, the first driving power source VDD may be set to a voltage higher than the second driving power source VSS.

The first initialization power source Vint1 may be a power source that initializes a gate electrode of a driving transistor included in each of the pixels PX. The first initialization power source Vint1 may be set to a voltage lower than the data signal. The second initialization power source Vint2 may be a power source that initializes a first electrode (or anode electrode) of a light emitting element LD included in each of the pixels PX. The second initialization power source Vint2 may be set to a voltage at which the light emitting element LD turns off. The bias power source Vbias may be a power source for applying an on bias voltage to the driving transistor included in each of the pixels PX.

The first driving power source VDD generated by the power supply unit 160 may be supplied to a first power source line PL1, the second driving power source VSS may be supplied to a second power source line PL2, the first initialization power source Vint1 may be supplied to a third power source line PL3, the second initialization power source Vint2 may be supplied to a fourth power source line PL4, and the bias power source Vbias may be supplied to a fifth power source line PL5. The first power source line PL1, the second power source line PL2, the third power source line PL3, the fourth power source line PL4, and the fifth power source line PL5 may be commonly connected to the pixels PX, but embodiments of the present inventive concept are not limited thereto.

In an embodiment, the first power source line PL1 may be composed of a plurality of power source lines, and the plurality of power source lines may be connected to different pixels PX. In an embodiment, the second power source line PL2 may be composed of a plurality of power source lines, and the plurality of power source lines may be connected to different pixels PX. In an embodiment, the third power source line PL3 may be composed of a plurality of power source lines, and the plurality of power source lines may be connected to different pixels PX. In an embodiment, the fourth power source line PL4 may be composed of a plurality of power source lines, and the plurality of power source lines may be connected to different pixels PX. In an embodiment, the fifth power source line PL5 may be composed of a plurality of power source lines, and the plurality of power source lines may be connected to different pixels PX. That is, in an embodiment of the present inventive concept, the pixels PX may be connected to one of first power source lines PL1, one of second power source lines PL2, one of third power source lines PL3, one of fourth power source lines PL4, and one of fifth power line PL5.

The power source generator 170 may generate a gate high voltage VGH, a first gate low voltage VGL1, and a second gate low voltage VGL2 using a first power source input from outside of the power source generator 170. At least two voltages among the gate high voltage VGH, the first gate low voltage VGL1, and the second gate low voltage VGL2 may be supplied to the scan driver 130 and/or the emission driver 150. The scan driver 130 and/or the emission driver 150 may generate a scan signal and an emission control signal using voltages supplied thereto (for example, at least two voltages among the gate high voltage VGH, the first gate low voltage VGL1, and the second gate low voltage VGL2).

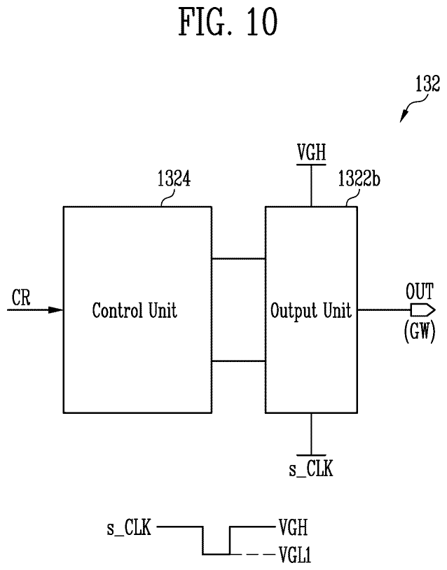

The gate high voltage VGH, the first gate low voltage VGL1, and the second gate low voltage VGL2 may be supplied to the timing controller 120. The timing controller 120 may generate a clock signal to be supplied to the scan driver 130 and/or the emission driver 150 using the gate high voltage VGH, the first gate low voltage VGL1, and the second gate low voltage VGL2. As an example, the timing controller 120 may generate a clock signal s_CLK (see FIG. 10) using the gate high voltage VGH and the first gate low voltage VGL1.

In addition, the timing controller 120 may generate a second clock signal using the gate high voltage VGH and the second gate low voltage VGL2. Here, the first gate low voltage VGL1 may be set to a voltage higher than the second gate low voltage VGL2. In addition, the gate high voltage VGH may be set to a voltage higher than the first gate low voltage VGL1 and the second gate low voltage VGL2.

In an embodiment of the present inventive concept, the display device 100 may include, for example, a flat panel display device, a curved display device in which a portion of the pixel unit 110 is curved, a flexible display device that can be partially folded or bent, or a stretchable display device that can be partially stretched.

In an embodiment of the present inventive concept, the display device 100 may be a device that displays a moving image or a still image and may include portable electronic devices such as, for example, a mobile phone, a smartphone, a tablet personal computer, a smartwatch, a watch phone, a mobile communication terminal, an electronic notebook, an e-book, a portable multimedia player (PMP), a navigation system, and an ultra-mobile PC (UMPC). In an embodiment of the present inventive concept, the display device 100 may include electronic devices such as, for example, a television, a laptop, a monitor, a billboard, and an Internet of Things (IoT) device.

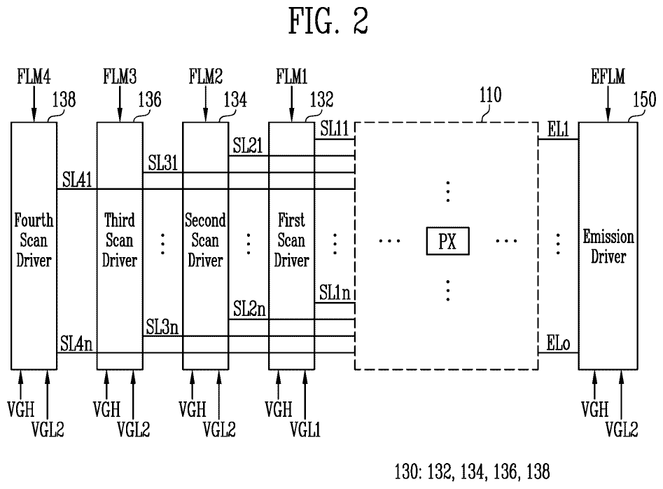

FIG. 2 is a diagram illustrating a scan driver and an emission driver according to an embodiment of the present inventive concept.

Referring to FIG. 2, the scan driver 130 according to an embodiment of the present inventive concept may include a first scan driver 132, a second scan driver 134, a third scan driver 136, and a fourth scan driver 138. Depending on the design, at least some of the scan drivers 132, 134, 136, and 138 may be integrated into one driving circuit, module, etc.

The first scan driver 132 may receive a first scan start signal FLM1 and generate an enable first scan signal while shifting the first scan start signal FLM1 in response to a clock signal. The first scan driver 132 may sequentially supply the enable first scan signal to the first scan lines SL11 to SL1n. In an embodiment, the first scan driver 132 may supply the enable first scan signal during a display scan period of one frame.

The first scan driver 132 may generate a first scan signal using the gate high voltage VGH and the first gate low voltage VGL1. As an example, a gate-off voltage of the first scan signal supplied to a P-type transistor may be set to the gate high voltage VGH, and a gate-on voltage may be set to the first gate low voltage VGL1. The enable first scan signal may be set to the first gate low voltage VGL1 so that the P-type transistor can be turned on, and a disable first scan signal may be set to the gate high voltage VGH so that the P-type transistor can be turned off. Additionally, the first gate low voltage VGL1 may be supplied to the first scan driver 132 in the form of a pulse.

The second scan driver 134 may receive a second scan start signal FLM2 and generate an enable second scan signal while shifting the second scan start signal FLM2 in response to a clock signal. The second scan driver 134 may sequentially supply the enable second scan signal to the second scan lines SL21 to SL2n. In an embodiment, the second scan driver 134 may supply the enable second scan signal during the display scan period of one frame.

The second scan driver 134 may generate a second scan signal using the gate high voltage VGH and the second gate low voltage VGL2. As an example, a gate-off voltage of the second scan signal supplied to an N-type transistor may be set to the second gate low voltage VGL2, and a gate-on voltage may be set to the gate high voltage VGH. The enable second scan signal may be set to the gate high voltage VGH so that the N-type transistor can be turned on, and a disable second scan signal may be set to the second gate low voltage VGL2 so that the N-type transistor can be turned off.

The third scan driver 136 may receive a third scan start signal FLM3 and generate an enable third scan signal while shifting the third scan start signal FLM3 in response to a clock signal. The third scan driver 136 may sequentially supply the enable third scan signal to the third scan lines SL31 to SL3n. In an embodiment, the third scan driver 136 may supply the enable third scan signal during the display scan period of one frame.

The third scan driver 136 may generate a third scan signal using the gate high voltage VGH and the second gate low voltage VGL2. As an example, a gate-off voltage of the third scan signal supplied to an N-type transistor may be set to the second gate low voltage VGL2, and a gate-on voltage may be set to the gate high voltage VGH. The enable third scan signal may be set to the gate high voltage VGH so that the N-type transistor can be turned on, and a disable third scan signal may be set to the second gate low voltage VGL2 so that the N-type transistor can be turned off.

The fourth scan driver 138 may receive a fourth scan start signal FLM4 and generate an enable fourth scan signal while shifting the fourth scan start signal FLM4 in response to a clock signal. The fourth scan driver 138 may sequentially supply the enable fourth scan signal to the fourth scan lines SL41 to SL4n.

In an embodiment, the fourth scan driver 138 may supply the enable fourth scan signal during a display scan period and self-scan period of one frame. For example, the fourth scan driver 138 may perform scanning once during the display scan period (that is, supply at least one enable fourth scan signal), and perform scanning at least once according to the image refresh rate during the self-scan period. When the image refresh rate is reduced (that is, the frame length becomes longer), the number of repetitions of the operation in which the fourth scan driver 138 supplies the enable fourth scan signal to each of the fourth scan lines SL41 to SL4n within one frame period may be increased.

The fourth scan driver 138 may generate a fourth scan signal using the gate high voltage VGH and the second gate low voltage VGL2. As an example, a gate-off voltage of the fourth scan signal supplied to a P-type transistor may be set to the gate high voltage VGH, and a gate-on voltage may be set to the second gate low voltage VGL2. The enable fourth scan signal may be set to the second gate low voltage VGL2 so that the P-type transistor can be turned on, and a disable fourth scan signal may be set to the gate high voltage VGH so that the P-type transistor can be turned off.

FIG. 2 shows the first scan driver 132, the second scan driver 134, the third scan driver 136, and the fourth scan driver 138 connected to the first scan line SL1, the second scan line SL2, the third scan line SL3, and the fourth scan line SL4, respectively, but embodiments of the present inventive concept are not limited thereto. For example, according to embodiments, at least two scan lines (at least two of SL1, SL2, SL3, and SL4) among the first scan line SL1, the second scan line SL2, the third scan line SL3, and the fourth scan line SL4 may be driven by one scan driver.

As an example, the second scan line SL2 and the third scan line SL3 may be driven by one scan driver. In this case, one of the second scan driver 134 and the third scan driver 136 shown in FIG. 2 may be omitted.

The emission driver 150 may receive an emission start signal EFLM and generate a disable emission control signal EM while shifting the emission start signal EFLM in response to a clock signal. The emission driver 150 may sequentially supply the disable emission control signal EM to the emission control lines EL1 to ELo.

The emission driver 150 may generate an emission control signal using the gate high voltage VGH and the second gate low voltage VGL2. As an example, a gate-off voltage of the emission control signal supplied to a P-type transistor may be set to the gate high voltage VGH, and a gate-on voltage may be set to the second gate low voltage VGL2. The disable emission control signal may be set to the gate high voltage VGH so that the P-type transistor can be turned off, and an enable emission control signal may be set to the second gate low voltage VGL2 so that the P-type transistor can be turned on.

In an embodiment, the emission driver 150 may supply the disable emission control signal during the display scan period and self-scan period of one frame. For example, the emission driver 150 may perform scanning once during the display scan period, and perform scanning at least once according to the image refresh rate during the self-scan period. When the image refresh rate is reduced (that is, the frame length becomes longer), the number of repetitions of the operation in which the emission driver 150 supplies the disable emission control signal to each of the emission control lines EL1 to ELo within one frame period may be increased.

FIG. 2 shows an embodiment in which the first to fourth scan drivers 132 to 138 are disposed on one side of the pixel unit 110, and the emission driver 150 is disposed on the other side of the pixel unit 110, but embodiments of the present inventive concept are not limited thereto.

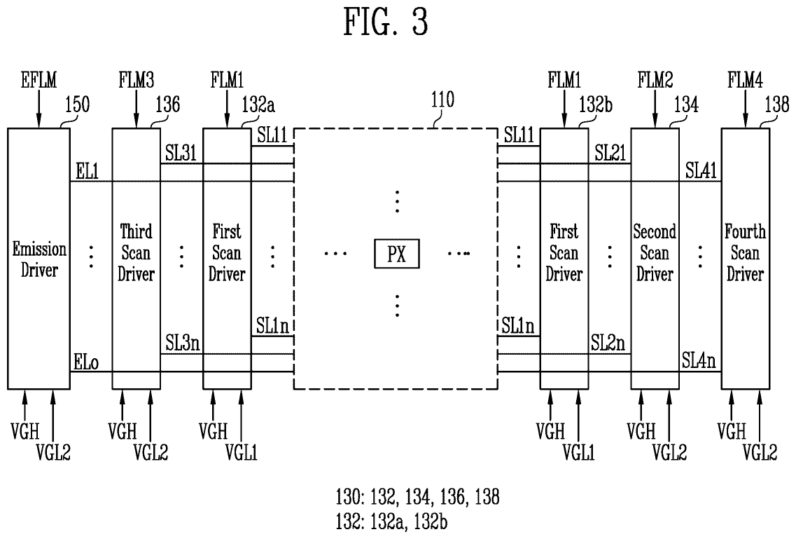

FIG. 3 is a diagram illustrating a scan driver and an emission driver according to an embodiment of the present inventive concept. In FIG. 3, compared to FIG. 2, the functions may be substantially the same except that the positions of the drivers are changed. Accordingly, for convenience of explanation, descriptions that overlap with those of FIG. 2 will be omitted.

Referring to FIG. 3, the first scan driver 132 may include sub-first scan drivers 132a and 132b. The sub-first scan driver 132a may be disposed on one side of the pixel unit 110, and the sub-first scan driver 132b may be disposed on the opposite side of the pixel unit 110.

The third scan driver 136 and the emission driver 150 may be disposed on one side of the pixel unit 110, and the second scan driver 134 and the fourth scan driver 138 may be disposed on the opposite side of the pixel unit 110. In an embodiment of the present inventive concept, the first scan driver 132, the second scan driver 134, the third scan driver 136, the fourth scan driver 138, and the emission driver 150 may be arranged in various shapes.

FIG. 4 is a diagram illustrating a pixel according to an embodiment of the present inventive concept. FIG. 4 shows a pixel located on an i-th horizontal line and a j-th vertical line.

Referring to FIG. 4, a pixel PXij according to an embodiment of the present inventive concept may be connected to corresponding signal lines SL1i, SL2i, SL3i, SL4i, ELk, and DLj. For example, the pixel PXij may be connected to an i-th first scan line SL1i, an i-th second scan line SL2i, an i-th third scan line SL3i, an i-th fourth scan line SL4i, a k-th emission control line ELk, and a j-th data line DLj. In an embodiment, the pixel PXij may be further connected to a first power source line PL1, a second power source line PL2, a third power source line PL3, a fourth power source line PL4, and a fifth power source line PL5.

The pixel PXij according to an embodiment of the present inventive concept may include a light emitting element LD and a pixel circuit that controls the amount of current supplied to the light emitting element LD.

The light emitting element LD may be connected between the first power source line PL1 and the second power source line PL2. As an example, a first electrode (or anode electrode) of the light emitting element LD may be electrically connected to the first power source line PL1 via a seventh transistor M7, a third node N3, a first transistor M1, a second node N2, and a sixth transistor M6. A second electrode (or cathode electrode) of the light emitting element LD may be electrically connected to the second power source line PL2. The light emitting element LD may generate light with a predetermined luminance in response to the amount of current supplied from the first power source line PL1 to the second power source line PL2 via the pixel circuit.

The light emitting element LD may be, for example, an organic light emitting diode or an inorganic light emitting diode, such as, for example, a micro LED (light emitting diode) or a quantum dot light emitting diode. In addition, the light emitting element LD may be an element composed of a combination of organic and inorganic materials. FIG. 4 shows the pixel PXij including a single light emitting element LD. However, embodiments of the present inventive concept are not limited thereto. For example, in an embodiment, the pixel PXij may include a plurality of light emitting elements LD, and the plurality of light emitting elements LD may be connected in series, in parallel, or in series and parallel.

The pixel circuit includes the first transistor M1, a second transistor M2, a third transistor M3, a fourth transistor M4, a fifth transistor M5, the sixth transistor M6, the seventh transistor M7, an eighth transistor M8, and a storage capacitor Cst.

A first electrode of the first transistor M1 (or driving transistor) may be connected to the second node N2, and a second electrode may be connected to the third node N3. In addition, a gate electrode of the first transistor M1 may be connected to a first node N1. The first transistor M1 may control the amount of current supplied from a first driving power source VDD to a second driving power source VSS via the light emitting element LD in response to a voltage of the first node N1.

The second transistor M2 (or write transistor) may be connected between a data line DLj and the second node N2 (or the first electrode of the first transistor M1). In addition, a gate electrode of the second transistor M2 may be electrically connected to a first scan line SL1i (or write scan line). The second transistor M2 may be turned on when an enable first scan signal GW (or write scan signal) is supplied to the first scan line SL1i to electrically connect to the data line DLj and the second node N2.

A first electrode of the third transistor M3 may be connected to the first node N1, and a second electrode may be electrically connected to the third power source line PL3. In addition, a gate electrode of the third transistor M3 may be electrically connected to a third scan line SL3i. The third transistor M3 may be turned on when an enable third scan signal GI is supplied to the third scan line SL3i to supply a voltage of a first initialization power source Vint1 to the first node N1.

The fourth transistor M4 may be connected between the first node N1 and the third node N3. In addition, a gate electrode of the fourth transistor M4 may be electrically connected to a second scan line SL2i. The fourth transistor M4 may be turned on when an enable second scan signal GC is supplied to the second scan line SL2i to electrically connect the first node N1 and the third node N3. That is, when the fourth transistor M4 is turned on, the first transistor M1 may be connected in the form of a diode.

A first electrode of the fifth transistor M5 (or initialization transistor) may be connected to the first electrode of the light emitting element LD, and a second electrode may be electrically connected to the fourth power source line PL4 (or initialization power source line). In addition, a gate electrode of the fifth transistor M5 may be electrically connected to a fourth scan line SL4i (or initialization scan line). The fifth transistor M5 may be turned on when an enable fourth scan signal GB (or initialization scan signal) is supplied to the fourth scan line SL4i to supply a voltage of a second initialization power source Vint2 to the first electrode of the light emitting element LD.

When the voltage of the second initialization power source Vint2 is supplied to the first electrode of the light emitting element LD, a parasitic capacitor of the light emitting element LD may be discharged. As the residual voltage charged in the parasitic capacitor of the light emitting element LD is discharged (or removed), unintentional weak light emitting can be prevented. Accordingly, the black expression ability of the pixel PXij can be improved.

A first electrode of the sixth transistor M6 may be electrically connected to the first power source line PL1, and a second electrode may be connected to the second node N2. In addition, a gate electrode of the sixth transistor M6 may be electrically connected to an emission control line ELk. The sixth transistor M6 may be turned off when a disable emission control signal EM is supplied to the emission control line ELk and may be turned on when an enable emission control signal EM is supplied.

The seventh transistor M7 may be connected between the third node N3 and the first electrode of the light emitting element LD. In addition, a gate electrode of the seventh transistor M7 may be electrically connected to the emission control line ELk. The seventh transistor M7 may be turned off when the disable emission control signal EM is supplied to the emission control line ELk and may be turned on when the enable emission control signal EM is supplied.

A first electrode of the eighth transistor M8 may be electrically connected to the fifth power source line PL5 (or bias power source line), and a second electrode may be connected to the second node N2. In addition, a gate electrode of the eighth transistor M8 may be electrically connected to the fourth scan line SL4i. The eighth transistor M8 may be turned on when the enable fourth scan signal GB is supplied to the fourth scan line SL4i to electrically connect the fifth power source line PL5 and the second node N2.

The storage capacitor Cst may be connected between the first power source line PL1 and the first node N1. The storage capacitor Cst may store a voltage applied to the first node N1.

In an embodiment, the first transistor M1, the second transistor M2, the fifth transistor M5, the sixth transistor M6, the seventh transistor M7, and the eighth transistor M8 may be composed of polysilicon semiconductor transistors. For example, the first transistor M1, the second transistor M2, the fifth transistor M5, the sixth transistor M6, the seventh transistor M7, and the eighth transistor M8 may include a polysilicon semiconductor layer formed through a low temperature poly-silicon (LTPS) process as an active layer (channel). In addition, the first transistor M1, the second transistor M2, the fifth transistor M5, the sixth transistor M6, the seventh transistor M7, and the eighth transistor M8 may be P-type transistors (for example, PMOS transistors). Accordingly, a gate-on voltage that turns on the first transistor M1, the second transistor M2, the fifth transistor M5, the sixth transistor M6, the seventh transistor M7, and the eighth transistor M8 may be a logic low level. The polysilicon semiconductor transistors may provide a fast response time, which can be applied to switching elements that operate with fast switching.

In an embodiment, the third transistor M3 and fourth transistor M4 may be composed of oxide semiconductor transistors. For example, the third transistor M3 and the fourth transistor M4 may be N-type oxide semiconductor transistors (for example, NMOS transistors) and may include an oxide semiconductor layer as an active layer. Accordingly, a gate-on voltage that turns on the third transistor M3 and the fourth transistor M4 may be a logic high level.

The oxide semiconductor transistors may be manufactured through a low-temperature process and may have lower charge mobility than polysilicon semiconductor transistors. That is, the oxide semiconductor transistors may have excellent off-current characteristics. Therefore, when the third transistor M3 and the fourth transistor M4 are composed of oxide semiconductor transistors, leakage current from the first node N1 due to low-frequency driving can be minimized, and display quality can be improved accordingly.

A gate-on voltage (or low voltage) of a fourth scan signal GB may be set to a lower voltage compared to the second initialization power source Vint2. As an example, when the second initialization power source Vint2 is set to about −4.5V, the gate-on voltage may be set to about −7V or less in consideration of a threshold voltage (for example, about −2.5V) of the fifth transistor M5. Here, the gate-on voltage of the fourth scan signal GB may be set to the second gate low voltage VGL2. Accordingly, the second gate low voltage VGL2 may be set to −about 7V or less.

When the second gate low voltage VGL2 is set to a low voltage of the fourth scan signal GB, low voltages of the remaining transistors M3, M4, M6, and M7 may also be set to the second gate low voltage VGL2.

In an embodiment of the present inventive concept, a low voltage of a first scan signal GW may be set to the first gate low voltage VGL1, which is a voltage higher than the second gate low voltage VGL2. A voltage of the data signal supplied to the data line DLj may be set to about 1.5V to about 7V. In this case, considering a threshold voltage (for example, about-2.5V) of the second transistor M2, a gate-on voltage of the second transistor M2 may be set to about-1.0V.

That is, the data signal supplied to the data line DLj may be set to a positive voltage. Accordingly, a low voltage of the second transistor M2 may be set to the first gate low voltage VGL1, which is higher than the second gate low voltage VGL2. In this case, the voltage swing width of the first scan signal GW may be narrowed, and thus, power consumption can be reduced.

In general, power consumption of the first scan driver 132 can be expressed as Equation 1 below.

$$P = {CV}^{2} f \qquad [ Equation 1 ]$$

In Equation 1, P refers to power consumption, C refers to capacitance, V refers to voltage, and f refers to frequency. In an embodiment of the present inventive concept, the low voltage of the first scan signal GW may be set to the first gate low voltage VGL1. In this case, a voltage (V) range can be reduced compared to a case in which the low voltage of the first scan signal GW is set to the second gate low voltage VGL2. Accordingly, power consumption can be reduced.

The structure of the pixel PXij in embodiments of the present inventive concept is not limited to the structure shown in FIG. 4. As an example, in embodiments of the present inventive concept, the pixel PXij may include the second transistor M2, the first transistor M1, and the fifth transistor M5 composed of P-type transistors, and other circuit configurations may be implemented with various types of pixel circuits.

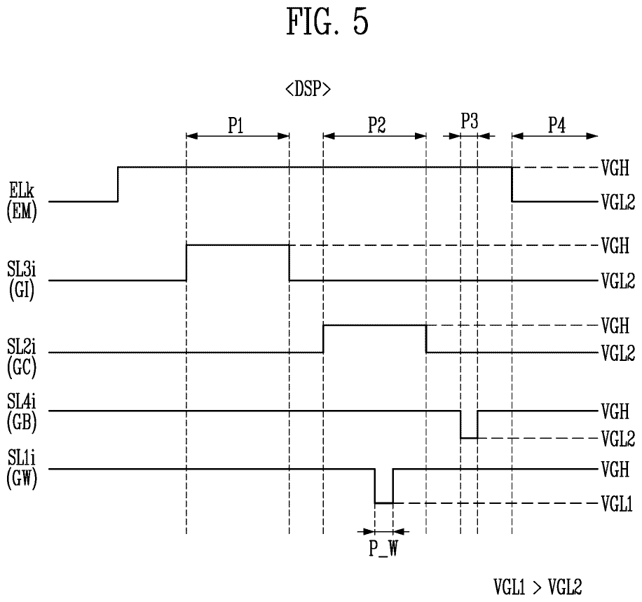

FIG. 5 is a waveform diagram illustrating an embodiment of a method of driving the pixel of FIG. 4 during a display scan period. The display scan period may be included in an active section of a frame.

Referring to FIGS. 4 and 5, a display scan period DSP may include a first section P1, a second section P2, a third section P3, and a fourth section P4. The first to third sections P1 to P3 may be set as non-emission sections, and the fourth section P4 may be set as an emission section. A second scan signal GC, a third scan signal GI, a fourth scan signal GB, and an emission control signal EM may have voltages of the gate high voltage VGH and the second gate low voltage VGL2, and a first scan signal GW may have voltages of the gate high voltage VGH and the first gate low voltage VGL1.

During the first to third sections P1 to P3, the disable emission control signal EM may be supplied to the emission control line ELk. When the disable emission control signal EM is supplied to the emission control line ELk, the sixth transistor M6 and the seventh transistor M7 may be turned off. When the sixth transistor M6 and the seventh transistor M7 are turned off, an electrical connection between the first power source line PL1 and the light emitting element LD may be cut off, and thus, the light emitting element LD may be set to a non-light emitting state.

During the first section P1, the enable third scan signal GI may be supplied to the third scan line SL3i. When the enable third scan signal GI is supplied to the third scan line SL3i, the third transistor M3 may be turned on. When the third transistor M3 is turned on, the voltage of the first initialization power source Vint1 of the third power source line PL3 may be supplied to the first node N1.

During the second section P2, the enable second scan signal GC may be supplied to the second scan line SL2i. Accordingly, the fourth transistor M4 may be turned on. When the fourth transistor M4 is turned on, the first transistor M1 may be connected in the form of a diode.

In a write section P_W overlapping the second section P2, the enable first scan signal GW may be supplied to the first scan line SL1i. When the enable first scan signal GW is supplied to the first scan line SL1i, the second transistor M2 may be turned on. When the second transistor M2 is turned on, the data signal may be supplied from the data line DLj to the second node N2. Since the first transistor M1 is connected in the form of a diode by the turned-on fourth transistor M4, the first node N1 may have a voltage in which a threshold voltage of the first transistor M1 is compensated for in the data signal.

During the third section P3, the enable fourth scan signal GB may be supplied to the fourth scan line SL4i. When the enable fourth scan signal GB is supplied to the fourth scan line SL4i, the fifth transistor M5 and the eighth transistor M8 may be turned on. When the fifth transistor M5 is turned on, the voltage of the second initialization power source Vint2 may be supplied to the first electrode of the light emitting element LD. Accordingly, the light emitting element LD may be initialized. When the eighth transistor M8 is turned on, a voltage of the bias power source Vbias may be supplied to the second node N2. When the voltage of the bias power source Vbias is supplied to the second node N2, the first transistor M1 may be set to an on-bias state.

In the fourth section P4, the enable emission control signal EM (or low-level emission control signal) may be supplied to the emission control line ELk to turn on the sixth transistor M6 and the seventh transistor M7. When the sixth transistor M6 and the seventh transistor M7 are turned on, a current movement path flowing to the second power source line PL2 through the first power source line PL1, the sixth transistor M6, the first transistor M1, the seventh transistor M7, and the light emitting element LD may be formed. In this case, depending on the operation of the first transistor M1, a driving current corresponding to the voltage of the first node N1 may flow through the light emitting element LD, and the light emitting element LD may emit light with a luminance corresponding to the driving current.

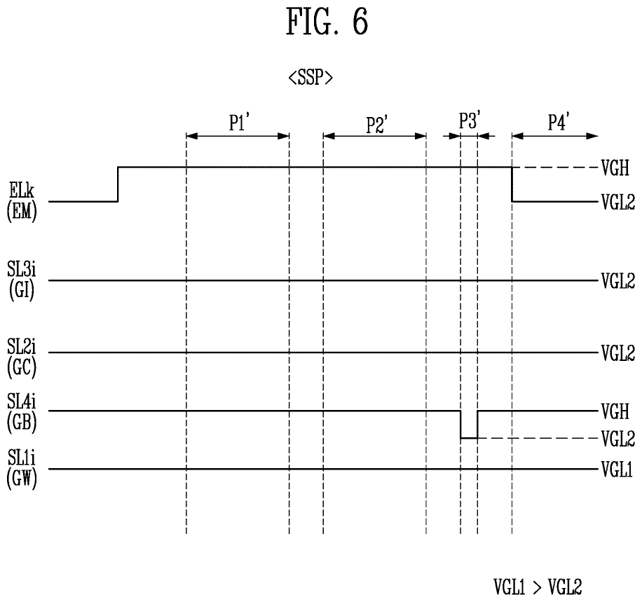

FIG. 6 is a waveform diagram illustrating an embodiment of a method of driving the pixel of FIG. 4 during a self-scan period. A self-scan period SSP may be a section in which light is emitted while maintaining the voltage of a previously supplied data signal, and may be a period in which the image is displayed again without the frame being switched. In an embodiment, one frame may include one display scan period DSP and one or more self-scan periods SSP. One or more self-scan periods SSP may be arranged consecutively after the display scan period DSP. The self-scan period SSP may be included in a blank section of a frame.

In the self-scan period SSP, compared to the display scan period DSP, an operation of compensating a threshold voltage and an operation of writing data may be omitted, and an operation of applying a bias voltage to the first transistor M1 (and an operation of initializing the light emitting element LD) and an operation of emitting light may be performed. The self-scan period SSP may be set to the same or similar length as the display scan period DSP. In this case, the self-scan period SSP may include a first section P1′, a second section P2′, a third section P3′, and a fourth section P4′.

Referring to FIGS. 4 and 6, in the first section P1′ to the third section P3′, the disable emission control signal EM may be supplied to the emission control line ELk. When the disable emission control signal EM is supplied to the emission control line ELk, the sixth transistor M6 and the seventh transistor M7 may be turned off. Accordingly, the light emitting element LD may be set to a non-light emitting state.

In an embodiment, in the first section P1′ to the third section P3′, the enable first scan signal GW, the enable second scan signal GC, and the enable third scan signal GI are not supplied (alternatively, the disable scan signals GW, GC, and GI may be supplied). Accordingly, in the first section P1′ to the third section P3′, the second transistor M2, the third transistor M3, and the fourth transistor M4 may be set to a turned-off state.

In the third section P3′, the enable fourth scan signal GB may be supplied to the fourth scan line SL4i. When the enable fourth scan signal GB is supplied to the fourth scan line SL4i, the fifth transistor M5 and the eighth transistor M8 may be turned on.

When the fifth transistor M5 is turned on, the voltage of the second initialization power source Vint2 may be supplied to the first electrode of the light emitting element LD, and thus, the light emitting element LD may be initialized. When the eighth transistor M8 is turned on, the voltage of the bias power source Vbias may be supplied to the second node N2. When the voltage of the bias power source Vbias is supplied to the second node N2, the first transistor M1 may be set to an on-bias state.

As described above, the display device 100 according to embodiments of the present inventive concept may be driven at various driving frequencies (various frame frequencies) because one frame includes the display scan period DSP and the self-scan period SSP.

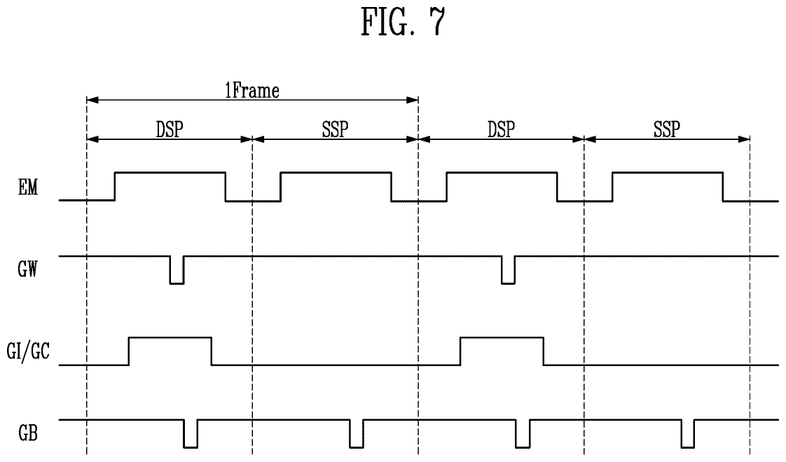

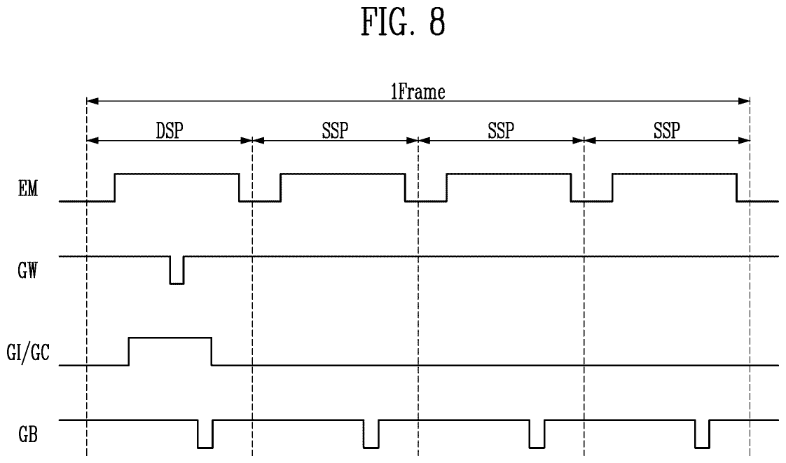

FIGS. 7 and 8 are diagrams illustrating an embodiment of signals supplied during an active period and a blank period. The scan signals GW, GC, GI, and GB shown in FIGS. 7 and 8 may indicate the supply status in the display scan period DSP and the self-scan period SSP. The second scan signal GC and the third scan signal GI may be supplied from one scan driver, and thus, may be shown as one signal.

Referring to FIG. 7, one display scan period DSP and one self-scan period SSP may be included during one frame period 1 Frame. In the display scan period DSP, the disable emission control signal EM, the enable first scan signal GW, the enable second scan signal GC, the enable third scan signal GI, and the enable fourth scan signal GB may be supplied.

In the self-scan period SS, the disable emission control signal EM and the enable fourth scan signal GB may be supplied. That is, the disable emission control signal EM and the enable fourth scan signal GB may be supplied in both the display scan period DSP and the self-scan period SSP, and the remaining scan signals GW, GC, and GI may be supplied only during the display scan period DSP.

As the driving frequency of the display device 100 decreases (for example, low-frequency driving), the number of self-scan periods SSP included in one frame period 1 Frame may increase, as shown in FIG. 8. Accordingly, the number of times the disable emission control signal EM and the enable fourth scan signal GB are supplied during one frame period 1 Frame may also be increased.

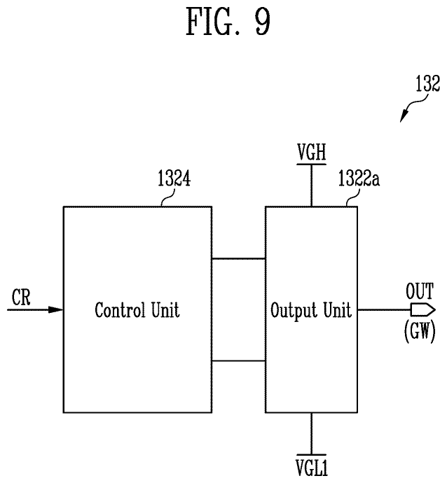

FIG. 9 is a diagram illustrating an embodiment of a stage circuit of a first scan driver. The first scan driver 132 may include stage circuits connected to each of the first scan lines SL11 to SL1n, and the stage circuits may sequentially generate the enable first scan signal GW.

Referring to FIG. 9, each of the stage circuits of the first scan driver 132 may include a control unit 1324 (also referred to as a control circuit) and an output unit 1322a (also referred to as an output circuit).

The control unit 1324 may receive a carry signal CR (or scan start signal) from a previous stage circuit and control the output unit 1322a in response to the carry signal CR. To this end, the control unit 1324 may additionally receive clock signals. The control unit 1324 may be implemented with various types of circuits.

The output unit 1322a may supply the first scan signal GW to an output terminal OUT using the gate high voltage VGH and the first gate low voltage VGL1. The output unit 1322a may supply the gate high voltage VGH or the first gate low voltage VGL1 to the output terminal OUT in response to the control of the control unit 1324. The output unit 1322a may be implemented with various types of circuits.

FIG. 10 is a diagram illustrating an embodiment of a stage circuit of the first scan driver. In describing FIG. 10, for convenience of explanation, overlapping descriptions of the same components as those described with reference to FIG. 9 will be omitted.

Referring to FIG. 10, the stage circuit of the first scan driver 132 may include a control unit 1324 and an output unit 1322b.

The output unit 1322b may supply the first scan signal GW to an output terminal OUT using the gate high voltage VGH and the clock signal s_CLK. A high voltage of the clock signal s_CLK may be set to the gate high voltage VGH, and a low voltage may be set to the first gate low voltage VGL1. The output unit 1322b may supply the gate high voltage VGH or the clock signal s_CLK to the output terminal OUT in response to the control of the control unit 1324. That is, the output unit 1322b may output the gate high voltage VGH as a high voltage of the first scan signal GW, and output the first gate low voltage GL1 of the clock signal s_CLK as the low voltage of the first scan signal GW. The output unit 1322b may be implemented with various types of circuits.

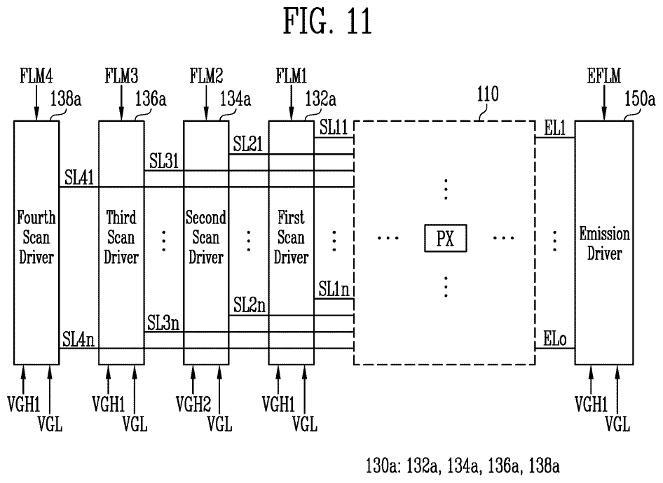

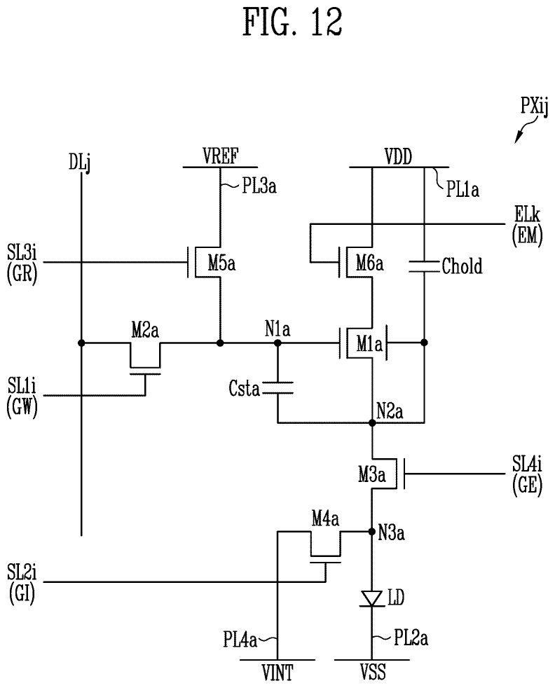

FIG. 11 is a diagram illustrating a scan driver and an emission driver according to an embodiment of the present inventive concept. A scan driver 130a and an emission driver 150a of FIG. 11 may supply a scan signal and an emission control signal to the pixel PXij shown in FIG. 12.

Referring to FIG. 11, the scan driver 130a according to an embodiment of the present inventive concept may include a first scan driver 132a, a second scan driver 134a, a third scan driver 136a, and a fourth scan driver 138a. Depending on the design, at least some of the scan drivers 132a, 134a, 136a, and 138a may be integrated into one driving circuit, module, etc.

The first scan driver 132a may receive a first scan start signal FLM1 and generate an enable first scan signal while shifting the first scan start signal FLM1 in response to a clock signal. The first scan driver 132a may sequentially supply the enable first scan signal to the first scan lines SL11 to SL1n. In an embodiment, the first scan driver 132a may supply the enable first scan signal during a display scan period of one frame.

The first scan driver 132a may generate a first scan signal using a first gate high voltage VGH1 and a gate low voltage VGL. As an example, a gate-off voltage of the first scan signal supplied to an N-type transistor may be set to the gate low voltage VGL, and a gate-on voltage may be set to the first gate high voltage VGH1. The enable first scan signal may be set to the first gate high voltage VGH1 so that the N-type transistor can be turned on, and a disable first scan signal may be set to the gate low voltage VGL so that the N-type transistor can be turned off.

The second scan driver 134a may receive a second scan start signal FLM2 and generate an enable second scan signal while shifting the second scan start signal FLM2 in response to a clock signal. The second scan driver 134a may sequentially supply the enable second scan signal to the second scan lines SL21 to SL2n. In an embodiment, the second scan driver 134a may supply the enable second scan signal during the display scan period and self-scan period of one frame.

The second scan driver 134a may generate a second scan signal using a second gate high voltage VGH2 and the gate low voltage VGL. As an example, a gate-off voltage of the second scan signal supplied to an N-type transistor may be set to the gate low voltage VGL, and a gate-on voltage may be set to the second gate high voltage VGH2. The enable second scan signal may be set to the second gate high voltage VGH2 so that the N-type transistor can be turned on, and a disable second scan signal may be set to the gate low voltage VGL so that the N-type transistor can be turned off. The first gate high voltage VGH1 may be set to a voltage higher than the second gate high voltage VGH2. This will be described in further detail below.

The third scan driver 136a may receive a third scan start signal FLM3 and generate an enable third scan signal while shifting the third scan start signal FLM3 in response to a clock signal. The third scan driver 136a may sequentially supply the enable third scan signal to the third scan lines SL31 to SL3n. In an embodiment, the third scan driver 136a may supply the enable third scan signal during the display scan period of one frame.

The third scan driver 136a may generate a third scan signal using the first gate high voltage VGH1 and the gate low voltage VGL. As an example, a gate-off voltage of the third scan signal supplied to an N-type transistor may be set to the gate low voltage VGL, and a gate-on voltage may be set to the first gate high voltage VGH1. The enable third scan signal may be set to the first gate high voltage VGH1 so that the N-type transistor can be turned on, and a disable third scan signal may be set to the gate low voltage VGL so that the N-type transistor can be turned off.

The fourth scan driver 138a may receive a fourth scan start signal FLM4 and generate an enable fourth scan signal while shifting the fourth scan start signal FLM4 in response to a clock signal. The fourth scan driver 138a may sequentially supply the enable fourth scan signal to the fourth scan lines SL41 to SLAn. In an embodiment, the fourth scan driver 138a may supply the enable fourth scan signal during the display scan period of one frame.

The fourth scan driver 138a may generate a fourth scan signal using the first gate high voltage VGH1 and the gate low voltage VGL. As an example, a gate-off voltage of the fourth scan signal supplied to an N-type transistor may be set to the gate low voltage VGL, and a gate-on voltage may be set to the first gate high voltage VGH1. The enable fourth scan signal may be set to the first gate high voltage VGH1 so that the N-type transistor can be turned on, and a disable fourth scan signal may be set to the gate low voltage VGL so that the N-type transistor can be turned off.

The emission driver 150a may receive an emission start signal EFLM and generate a disable emission control signal EM while shifting the emission start signal EFLM in response to a clock signal. The emission driver 150a may sequentially supply the disable emission control signal EM to the emission control lines EL1 to ELo.

The emission driver 150a may generate an emission control signal using the first gate high voltage VGH1 and the gate low voltage VGL. As an example, a gate-off voltage of the emission control signal supplied to an N-type transistor may be set to the gate low voltage VGL, and a gate-on voltage may be set to the first gate high voltage VGH1. The disable emission control signal may be set to the gate low voltage VGL so that the N-type transistor can be turned off, and an enable emission control signal may be set to the first gate high voltage VGH1 so that the N-type transistor can be turned on.

In an embodiment, the emission driver 150a may supply the disable emission control signal during the display scan period and self-scan period of one frame. For example, the emission driver 150 may perform scanning once during the display scan period, and may perform scanning at least once according to the image refresh rate during the self-scan period. When the image refresh rate is reduced (that is, the frame length becomes longer), the number of repetitions of the operation in which the emission driver 150a supplies the disable emission control signal to each of the emission control lines EL1 to ELo within one frame period may be increased.

FIG. 12 is a diagram illustrating a pixel according to an embodiment of the present inventive concept. FIG. 12 shows a pixel located on an i-th horizontal line and a j-th vertical line.

Referring to FIG. 12, a pixel PXij according to an embodiment of the present inventive concept may be connected to corresponding signal lines SL1i, SL2i, SL3i, SL4i, DLj, and Elk. For example, the pixel PXij may be connected to an i-th first scan line SL1i, an i-th second scan line SL2i, an i-th third scan line SL3i, an i-th fourth scan line SL4i, a k-th emission control line Elk, and a j-th data line DLj.

The pixel PXij according to an embodiment of the present inventive concept may include a light emitting element LD and a pixel circuit that controls the amount of current supplied to the light emitting element LD.

The light emitting element LD may be connected between a first power source line PL1a and a second power source line PL2a. As an example, a first electrode (for example, an anode electrode) of the light emitting element LD may be connected to the first power source line PL1a via a third node N3a, a third transistor M3a (also referred to as a first emission transistor), a second node N2a, a first transistor M1a (also referred to as a driving transistor), and a sixth transistor M6a (also referred to as a second emission transistor), and a second electrode (for example, a cathode electrode) of the light emitting element LD may be connected to the second power source line PL2a. The light emitting element LD may generate light with a luminance corresponding to the amount of current supplied from the pixel circuit.

The light emitting element LD may be, for example, an organic light emitting diode or an inorganic light emitting diode, such as, for example, a micro LED (light emitting diode) or a quantum dot light emitting diode. In addition, the light emitting element LD may be an element composed of a combination of organic and inorganic materials. FIG. 12 shows the pixel PXij including a single light emitting element LD. However, embodiments of the present inventive concept are not limited thereto. For example, in an embodiment, the pixel PXij may include a plurality of light emitting elements LD, and the plurality of light emitting elements LD may be connected in series, in parallel, or in series and parallel.

The pixel circuit may include the first transistor M1a (also referred to as a driving transistor), a second transistor M2a, the third transistor M3a (also referred to as a first emission transistor), a fourth transistor M4a, a fifth transistor M5a (also referred to as a control transistor), the sixth transistor M6a (also referred to as a second emission transistor), a first capacitor Csta, and a second capacitor Chold. Here, the first to sixth transistors M1a to M6a may be oxide semiconductor transistors. For example, an active layer (or semiconductor layer) of the first to sixth transistors M1a to M6a may include an oxide semiconductor layer. In an embodiment, the first to sixth transistors M1a to M6a may be N-type oxide semiconductor transistors.

A first electrode of the first transistor M1a (or driving transistor) may be connected to a second electrode of the sixth transistor M6a, and a second electrode of the first transistor M1a may be connected to the second node N2a. In addition, a first gate electrode of the first transistor M1a may be connected to a first node N1a, and a second gate electrode (or back gate electrode) of the first transistor M1a may be connected to the second node N2a. The first transistor M1a may control the amount of current supplied from a first driving power source VDD to a second driving power source VSS via the light emitting element LD in response to a voltage of the first node N1a.

The first transistor M1a may be composed of a double gate transistor including the first gate electrode and the second gate electrode. When the second gate electrode is connected to the second node N2a, a gate-source voltage and driving current of the first transistor M1a can be maintained stably.

The second transistor M2a (or write transistor) may be connected between the data line DLj and the first node N1a. In addition, a gate electrode of the second transistor M2a may be connected to a first scan line SL1i (write scan signal). The second transistor M2a may be turned on when an enable first scan signal GW (or write scan signal) is supplied to the first scan line SL1i to electrically connect the data line DLj and the first node N1a.

The third transistor M3a (or first light emitting transistor) may be connected between the second node N2a and the third node N3a (or the anode electrode of the light emitting element). The second node N2a may refer to a node where the second electrode of the first transistor M1a and a first electrode of the third transistor M3a are electrically connected to each other, and the third node N3a may refer to a node to which the first electrode of the light emitting element LD is connected. A gate electrode of the third transistor M3a may be connected to a fourth scan line SLAi. The third transistor M3a may be turned on when an enable fourth scan signal GE (or first control scan signal) is supplied to the fourth scan line SLAi.

When the third transistor M3a is turned on, the second node N2a and the third node N3a may be electrically connected to each other. Accordingly, the first transistor M1a and the light emitting element LD may be electrically connected to each other. When the third transistor M3a is turned off, the second node N2a and the third node N3a may be electrically isolated. Accordingly, a current path through which the driving current flows to the light emitting element LD may be cut off.

The fourth transistor M4a (or initialization transistor) may be connected between the third node N3a and a fourth power source line PL4a (or initialization power source line). In addition, a gate electrode of the fourth transistor M4a may be connected to a second scan line SL2i (or initialization scan signal). The fourth transistor M4a may be turned on when an enable second scan signal GI (or initialization scan signal) is supplied to the second scan line SL2i to electrically connect the fourth power source line PL4a and the third node N3a.

When the fourth power source line PL4a and the third node N3a are electrically connected to each other, a voltage of the initialization power source VINT from the fourth power source line PL4a may be supplied to the third node N3a. Then, a parasitic capacitor equivalently formed in the light emitting element LD may be discharged, and thus, the black expression ability can be improved.

The fifth transistor M5a may be connected between a third power source line PL3a (or reference power source line) and the first node N1a. In addition, a gate electrode of the fifth transistor M5a may be connected to a third scan line SL3i. The fifth transistor M5a may be turned on when an enable third scan signal GR (or second control scan signal) is supplied to the third scan line SL3i to electrically connect the third power source line PL3a and the first node N1a. When the third power source line PL3a and the first node N1a are electrically connected to each other, a voltage of the reference power source VREF may be supplied to the first node N1a.

The sixth transistor M6a (or second light emitting transistor) may be connected between the first power source line PL1a and the first electrode of the first transistor M1a. In addition, a gate electrode of the sixth transistor M6a may be connected to the emission control line ELk. The sixth transistor M6a may be turned off when a disable emission control signal EM (or low level emission control signal EM) is supplied to the emission control line ELk, and may be turned on in other cases. When the sixth transistor M6a is turned on, a current path through which the driving current flows through the pixel PXij may be formed.

The first capacitor Csta may be connected between the first node N1a and the second node N2a. A voltage corresponding to the data signal may be stored in the first capacitor Cst.

The second capacitor Chold may be connected between the first power source line PL1a and the second node N2a. The second capacitor Chold may stabilize a voltage of the second node N2a.

A gate-on voltage (or high voltage) of the first scan signal GW must be set to a voltage higher than the data signal supplied to the data line DLj. As an example, when a voltage of the data signal is set to about 1.5V to about 7V, the gate-on voltage of the first scan signal GW may be set to about 10V in consideration of a threshold voltage of the second transistor M2a. Here, the gate-on voltage of the first scan signal GW may be set to the first gate high voltage VGH1.

The first gate high voltage VGH1 may be set to the gate-on voltage of the first scan signal GW, and gate-on voltages of the remaining transistors M3a, M5a, and M6a may also be set to the first gate high voltage VGH1.

In an embodiment of the present inventive concept, a gate-on voltage of a second scan signal GI may be set to the second gate high voltage VGH2, which is lower than the first gate high voltage VGH1. The fourth transistor M4a may receive a voltage of the initialization power source VINT that is lower than the data signal. Accordingly, the gate-on voltage of the second scan signal GI may be set to the second gate high voltage VGH2 that is lower than the first gate high voltage VGH1. In this case, the voltage swing width of the second scan signal GI may be reduced, and thus, power consumption can be reduced.

In an embodiment of the present inventive concept, a gate-on voltage of a third scan signal GR may be set to the second gate high voltage VGH2. As an example, when the voltage of the reference power source VREF is set to a voltage similar to the lowest grayscale of the data signal, the gate-on voltage of the third scan signal GR may be set to the second gate high voltage VGH2.

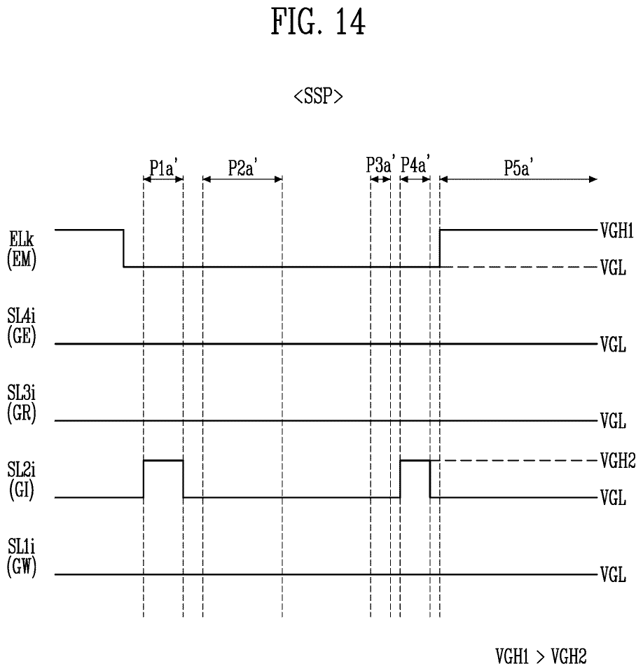

The structure of the pixel PXij is not limited to the structure shown in FIG. 14. For example, in an embodiment of the present inventive concept, the pixel PXij may include the second transistor M2a, the first transistor M1a, and the fourth transistor M4a composed of N-type transistors, and other circuit configurations may be implemented with various types of pixel circuits.

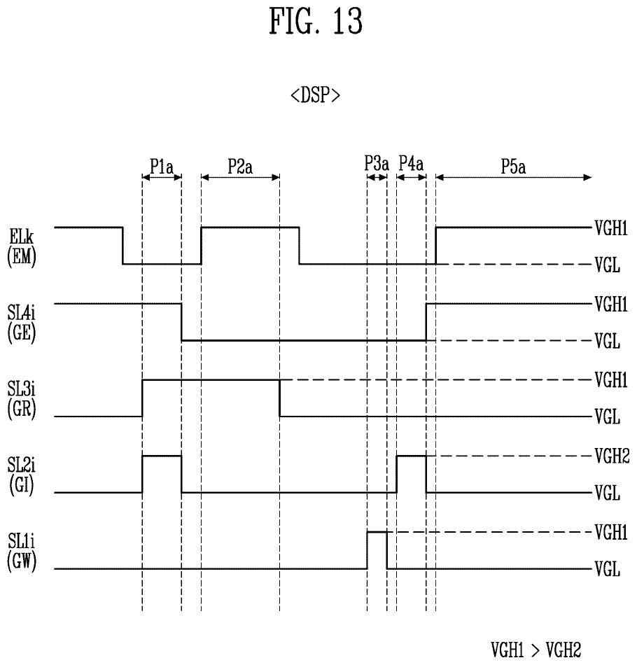

FIG. 13 is a diagram illustrating an embodiment of a method of driving the pixel of FIG. 12 during a display scan period. The display scan period DSP may be included in an active section of a frame.

Referring to FIGS. 12 and 13, a method of driving the pixel PXij may include a first period Pla, a second period P2a, a third period P3a, a fourth period P4a, and a fifth period P5a.

The first scan signal GW, the third scan signal GR, a fourth scan signal GE, and an emission control signal EM may have voltages of the first gate high voltage VGH1 and the gate low voltage VGL, and the second scan signal GI may have voltages of the second gate high voltage VGH2 and the gate low voltage VGL.

The first period Pla may be a period in which the first capacitor Csta is initialized. The second period P2a may be a period in which a threshold voltage of the first transistor M1a is compensated for. The third period P3a may be a period in which the voltage of the data signal is stored in the pixel PXij. The fourth period P4a may be a period in which the light emitting element LD is initialized. The fifth period P5a may be a period in which the pixel PXij (or light emitting element LD) emits light.

During the first period Pla, the enable second scan signal GI may be supplied to the second scan line SL2i, the enable third scan signal GR may be supplied to the third scan line SL3i, and the enable fourth scan signal GE may be supplied to the fourth scan line SL4i. In addition, the disable emission control signal EM may be supplied to the emission control line ELk.

When the disable emission control signal EM is supplied to the emission control line ELk, the sixth transistor M6a may be turned off. When the sixth transistor M6a is turned off, the electrical connection between the first power source line PL1a and the first transistor M1a may be cut off, and thus, the light emitting element LD may be set to a non-light emitting state.

When the enable second scan signal GI is supplied to the second scan line SL2i, the fourth transistor M4a may be turned on. When the fourth transistor M4a is turned on, the voltage of the initialization power source VINT may be supplied to the third node N3a. When the enable fourth scan signal GE is supplied to the fourth scan line SL4i, the third transistor M3a may be turned on. When the third transistor M3a is turned on, the voltage of the initialization power source VINT of the third node N3a may be supplied to the second node N2a.

When the enable third scan signal GR is supplied to the third scan line SL3i, the fifth transistor M5a may be turned on. When the fifth transistor M5a is turned on, the voltage of the reference power source VREF may be supplied to the first node N1a. When the voltage of the reference power source VREF is supplied to the first node N1a and the voltage of the initialization power source VINT is supplied to the second node N2a, the first capacitor Csta and the second capacitor Chold may be initialized. That is, the first period Pla may be a period in which the pixel PXij is initialized so that it is not affected by the data signal supplied in a previous frame period.

During the second period P2a, the supply of the disable emission control signal EM to the emission control line ELk may be stopped (or the enable (high level) emission control signal EM may be supplied to the emission control line ELk), and the enable third scan signal GR may be supplied to the third scan line SL3i. The enable third scan signal GR supplied to the third scan line SL3i may be supplied during the first period Pla and the second period P2a.

When the supply of the disable emission control signal EM to the emission control line ELk is stopped, the sixth transistor M6a may be turned on. Accordingly, the voltage of the first driving power source VDD may be supplied to the first electrode of the first transistor M1a. When the enable third scan signal GR is supplied to the third scan line SL3i, the fifth transistor M5a may be turned on. Accordingly, the voltage of the reference power source VREF may be supplied to the first node N1a.

Here, the voltage of the reference power source VREF may be set so that the first transistor M1a can be turned on. Accordingly, the voltage of the second node N2a may be increased in response to the current supplied from the first transistor M1a. The voltage of the second node N2a may be increased to a value obtained by subtracting an absolute value of the threshold voltage of the first transistor M1a. That is, during the second period P2a, a voltage corresponding to the threshold voltage of the first transistor M1a may be stored in the first capacitor Csta.

The width of the second period P2a may be determined by the supply time of the enable emission control signal EM and the enable third scan signal GR. That is, in an embodiment of the present inventive concept, the compensation time (that is, the second period P2a) of the threshold voltage of the first transistor M1a may be controlled using the supply time of the enable emission control signal EM and the enable third scan signal GR.

During the third period P3a, the disable emission control signal EM may be supplied, and thus, the sixth transistor M6a may be turned off. During the third period P3a, the enable first scan signal GW may be supplied to the first scan line SL1i. When the enable first scan signal GW is supplied to the first scan line SL1i, the second transistor M2a may be turned on. When the second transistor M2a is turned on, the data signal from the data line DLj may be supplied to the first node N1a.

Voltages of the first node N1a and the second node N2a during the third period P3a may be expressed as Equation 2 below.

$$VN 1 a = Vdata \qquad [ Equation 2 ]$$

$$VN 2 a = VREF - Vth 1$$

In Equation 2, Vdata may refer to the voltage of the data signal, and Vth1 may refer to the threshold voltage of the first transistor M1a.

In Equation 2, for convenience of description, it is described that the second node N2a maintains a voltage of VREF-Vth1 during the third period P3a, but embodiments of the present inventive concept are not limited thereto.

As an example, during the third period P3a, the voltage of the first node N1a may be changed from the voltage of the reference power source VREF to the voltage of the data signal Vdata, and the voltage of the second node N2a may also be changed by coupling of the first capacitor Csta. However, the voltage of the second node N2a may be changed in response to a ratio of the first capacitor Csta and the second capacitor Chold. Accordingly, the amount of change in voltage at the second node N2a can be reduced. Hereafter, for convenience of description, it is assumed that the second node N2a maintains a voltage of VREF-Vth1 during the third period P3a.

During the fourth period P4a, the supply of the disable emission control signal EM may be maintained, and the enable second scan signal GI may be supplied to the second scan line SL2i. When the enable second scan signal GI is supplied to the second scan line SL2i, the fourth transistor M4a may be turned on. When the fourth transistor M4a is turned on, the voltage of the initialization power source VINT may be supplied to the third node N3a. When the voltage of the initialization power source VINT is supplied to the third node N3a, the first electrode of the light emitting element LD (or the parasitic capacitor of the light emitting element LD) may be initialized with the voltage of the initialization power source VINT.

During the fifth period P5a, the enable emission control signal EM may be supplied to the emission control line ELk. When the enable emission control signal EM is supplied to the emission control line ELk, the sixth transistor M6a may be turned on. When the sixth transistor M6a is turned on, the first power source line PL1 and the first transistor M1a may be electrically connected to each other.

Also, during the fifth period P5a, the enable fourth scan signal GE may be supplied to the fourth scan line SL4i. When the enable fourth scan signal GE is supplied to the fourth scan line SL4i, the third transistor M3a may be turned on. When the third transistor M3a is turned on, the second node N2a and the third node N3a may be electrically connected to each other.

In this case, the first transistor M1a may supply a driving current corresponding to the voltage of the first node N1a from the first driving power source VDD to the second driving power source VSS via the light emitting element LD. Then, during the fifth period P5a, the light emitting element LD may generate light with a luminance corresponding to the driving current. The fifth period P5a may be an emission period.

FIG. 14 is a diagram illustrating an embodiment of a method of driving the pixel of FIG. 12 during a self-scan period.

Referring to FIGS. 12 to 14, in an embodiment of the present inventive concept, a frame period may include one display scan period DSP and at least one self-scan period SSP.

The display scan period DSP may be a period in which the voltage of the data signal is stored in the pixels PX, and the driving signals of FIG. 13 described above may be supplied. That is, the display scan period DSP may include the first period Pla, the second period P2a, the third period P3a, the fourth period P4a, and the fifth period P5a shown in FIG. 13. The enable scan signals GW, GI, GR, and GE and the disable emission control signal EM may be supplied in each corresponding period (at least one period among Pla to P5a).

The self-scan period SSP may be a period in which the pixels PX are set to a non-light emitting state for a part of the period while maintaining the data signal supplied in the display scan period DSP. One or more of self-scan periods SSP may be included in the frame period. When the self-scan period SSP is included in one frame period, the pixels PX may be set to a non-light emitting state at regular intervals. Accordingly, the quality of a moving image can be improved.

As shown in FIG. 14, the self-scan period SSP may include a first period Pla′, a second period P2a′, a third period P3a′, a fourth period P4a′, and a fifth period P5a′ corresponding to the first period Pla, the second period P2a, the third period P3a, the fourth period P4a, and the fifth period P5a of FIG. 13.

During the first period P1a′ to the fourth period P4a′ of the self-scan period SSP, the disable emission control signal EM may be supplied to the emission control line ELk. When the disable emission control signal EM is supplied to the emission control line ELk, the sixth transistor M6a may be turned off. Accordingly, during the first period P1a′ to the fourth period P4a′, the light emitting element LD may be set to a non-light emitting state.

During the first period P1a′ and the fourth period P4a′ of the self-scan period SSP, the enable second scan signal GI may be supplied to the second scan line SL2i. When the enable second scan signal GI is supplied to the second scan line SL2i, the fourth transistor M4a may be turned on. Accordingly, the first electrode of the light emitting element LD may be initialized with the voltage of the initialization power source VINT.

During the fifth period P5a′ of the self-scan period SSP, the enable emission control signal EM may be supplied to the emission control line ELk. When the enable emission control signal EM is supplied to the emission control line ELk, the sixth transistor M6a may be turned on. When the sixth transistor M6a is turned on, the first power source line PL1a and the first transistor M1a may be electrically connected to each other.

In this case, the first transistor M1a may supply a driving current corresponding to the voltage of the first node N1a from the first driving power source VDD to the second driving power source VSS via the light emitting element LD. Then, during the fifth period P5a′, the light emitting element LD may generate light with a luminance corresponding to the driving current.

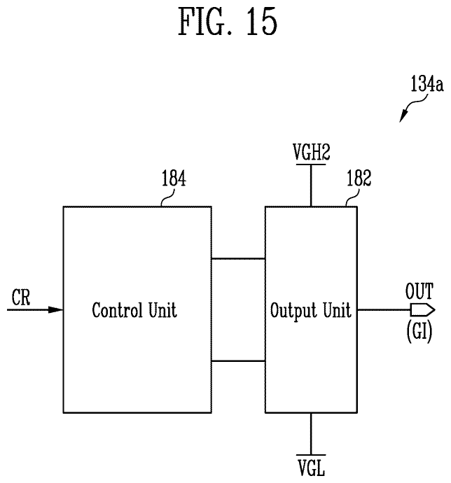

FIG. 15 is a diagram illustrating an embodiment of a stage circuit of a second scan driver shown in FIG. 11. The second scan driver 134a may include stage circuits connected to each of the second scan lines SL21 to SL2n. The stage circuits may sequentially generate the enable second scan signal GI.

Referring to FIG. 15, each of the stage circuits of the second scan driver 134a may include a control unit 184 and an output unit 182.

The control unit 184 may receive a carry signal CR (or scan start signal) from a previous stage circuit and control the output unit 182 in response to the carry signal CR. To this end, the control unit 184 may additionally receive clock signals. The control unit 184 may be implemented with various types of circuits.

The output unit 182 may supply the second scan signal GI to an output terminal OUT using the second gate high voltage VGH2 and the gate low voltage VGL. The output unit 182 may supply the second gate high voltage VGH2 or the gate low voltage VGL to the output terminal OUT in response to the control of the control unit 184. The output unit 182 may be implemented with various types of circuits. Additionally, the second gate high voltage VGH2 and/or the gate low voltage VGL may be supplied to the output unit 182 in the form of a pulse signal.

A display device according to embodiments of the present inventive concept may reduce power consumption by reducing a gate high voltage of a scan signal or increasing a gate low voltage of the scan signal.

However, effects of the present inventive concept are not limited to the above-described effects, and may be variously extended without departing from the spirit and scope of the present inventive concept.

While the present inventive concept has been particularly shown and described with reference to embodiments thereof, it will be understood by those of ordinary skill in the art that various changes in form and detail may be made therein without departing from the spirit and scope of the present inventive concept as defined by the following claims.

What is claimed is:

1. A display device, comprising:
a pixel unit including a plurality of pixels,
wherein each of the pixels includes:
a light emitting element;
a driving transistor configured to control an amount of current flowing from a first power source line to a second power source line via the light emitting element in response to a voltage of a first node;
a write transistor connected between a first electrode of the driving transistor and a data line, and configured to be turned on or off in response to a write scan signal; and
an initialization transistor connected between an anode electrode of the light emitting element and an initialization power source line, and configured to be turned on or off in response to an initialization scan signal,
wherein a low voltage of the write scan signal is set to a first gate low voltage, and a low voltage of the initialization scan signal is set to a second gate low voltage that is different from the first gate low voltage.

2. The display device of claim 1, wherein the write transistor and the initialization transistor are P-type transistors.

3. The display device of claim 1, wherein a high voltage of the write scan signal and a high voltage of the initialization scan signal are set to a gate high voltage.

4. The display device of claim 1, wherein the first gate low voltage is a voltage higher than the second gate low voltage.

5. The display device of claim 1, further comprising:
a data driver configured to supply a data signal to the data line;
a first scan driver configured to supply the write scan signal to a write scan line; and
a second scan driver configured to supply the initialization scan signal to an initialization scan line.

6. The display device of claim 5, wherein the first scan driver includes a plurality of stage circuits, and
wherein each of the stage circuits includes:
an output unit configured to generate the write scan signal using a gate high voltage and the first gate low voltage; and
a control unit configured to control the output unit.

7. The display device of claim 5, wherein the first scan driver includes a plurality of stage circuits, and
wherein each of the stage circuits includes:
an output unit configured to generate the write scan signal using a gate high voltage and a clock signal; and
a control unit configured to control the output unit.

8. The display device of claim 7, wherein a high voltage of the clock signal is set to the gate high voltage, and a low voltage of the clock signal is set to the first gate low voltage.

9. A display device, comprising:
a pixel unit including a plurality of pixels,
wherein each of the pixels includes:
a light emitting element;
a driving transistor configured to control an amount of current flowing from a first power source line to a second power source line via the light emitting element in response to a voltage of a first node;
a write transistor connected between the first node and a data line, and configured to be turned on or off in response to a write scan signal; and
an initialization transistor connected between an anode electrode of the light emitting element and an initialization power source line, and configured to be turned on or off in response to an initialization scan signal,
wherein a high voltage of the write scan signal is set to a first gate high voltage, and a high voltage of the initialization scan signal is set to a second gate high voltage.

10. The display device of claim 9, wherein the write transistor and the initialization transistor are N-type transistors.

11. The display device of claim 9, wherein a low voltage of the write scan signal and a low voltage of the initialization scan signal are set to a gate low voltage.

12. The display device of claim 9, wherein the first gate high voltage is a voltage higher than the second gate high voltage.

13. The display device of claim 9, wherein each of the pixels further includes:
a first emission transistor connected between a second electrode of the driving transistor and the anode electrode of the light emitting element, and configured to be turned on or off by a first control scan signal;
a second emission transistor connected between the first power source line and a first electrode of the driving transistor, and configured to be turned on or off by an emission control signal;
a control transistor connected between a reference power source line and the first node, and configured to be turned on or off by a second control scan signal;
a first capacitor connected between the first node and the second electrode of the driving transistor; and
a second capacitor connected between the first power source line and the second electrode of the driving transistor,
wherein the first emission transistor, the second emission transistor, and the control transistor are N-type transistors.

14. The display device of claim 13, wherein a high voltage of each of the first control scan signal, the second control scan signal, and the emission control signal is set to the first gate high voltage, and a low voltage of each of the first control scan signal, the second control scan signal, and the emission control signal is set to a gate low voltage.

15. The display device of claim 13, wherein a high voltage of each of the first control scan signal and the emission control signal is set to the first gate high voltage, and a low voltage of each of the first control scan signal and the emission control signal is set to a gate low voltage, and
wherein a high voltage of the second control scan signal is set to the second gate high voltage, and a low voltage of the second control scan signal is set to the gate low voltage.

16. The display device of claim 9, further comprising:
a data driver configured to supply a data signal to the data line;
a first scan driver configured to supply the write scan signal to a write scan line; and
a second scan driver configured to supply the initialization scan signal to an initialization scan line.

17. The display device of claim 16, wherein the second scan driver includes a plurality of stage circuits, and
wherein each of the stage circuits includes:
an output unit configured to generate the initialization scan signal using the second gate high voltage and a gate low voltage; and
a control unit configured to control the output unit.

18. A display device, comprising:
a pixel unit including a plurality of pixels connected to a plurality of first scan lines, a plurality of second scan lines, and a plurality of data lines;
a power source generator configured to generate a gate high voltage, a first gate low voltage, and a second gate low voltage using a first power source input from outside of the power source generator and a second power source having a voltage lower than the first power source;
a scan driver configured to generate a first scan signal to be supplied to the first scan lines using the gate high voltage and the first gate low voltage, and configured to generate a second scan signal to be supplied to the second scan lines using the gate high voltage and the second gate low voltage; and
a data driver configured to supply a data signal to the data lines.
